(19) United States
(12) Patent Application Publication
(10) Pub. No.: US 2002/0094789 A1
(43) Pub. Date: Jul. 18, 2002

(54) Portable radio terminal device

(76) Inventor: Nobuya Harano, Shizuoka (JP)

Correspondence Address: WHITHAM, CURTIS & CHRISTOFFERSON, P.C., 11491 SUNSET HILLS ROAD, SUITE 340, RESTON, VA, 20190, US

(21) Appl. No.: 10/043,154

(22) Filed: Jan. 14, 2002

(30) Foreign Application Priority Data
Jan. 15, 2001 (JP) 005978/2001

(51) Int. Cl. H04B 1/38

(52) U.S. Cl. 455/90; 455/575

(57) ABSTRACT

A first and a second transmission antenna 2 and 3 are disposed in a lower and an upper part, respectively, of a housing 1. One of the two transmission antennas 2 and 3 is predetermined to be a normally used transmission antenna, in the neighborhood of which a sensor 8 is disposed. When the user's hand 4 covers the first transmission antenna 2, the control part 6 feeds out a control signal to the control part 6, whereupon an antenna select switch 7 automatically switches the first transmission antenna 2 over to the second transmission antenna 3.

### BACKGROUND OF THE INVENTION

This application claims benefit of Japanese Patent Application No. 2001-005978 filed on Jan. 15, 2001, the contents of which are incorporated by the reference.

The present invention relates to portable radio terminal devices with antennas, which is capable of being held by one hand of the user (or operator) for radio communication.

Recently, portable radio terminals such as data terminals have been rapidly becoming popular with the progress of mobile communication such as portable telephone and computer network techniques. For example, when a businessman visiting a customer has a business talk, he or she uses such a portable radio terminal to obtain newest data relevant to the price and term as requested by the customer and so forth from a computer network of the own company by using such a portable radio terminal and show the obtained data to the customer. Also, such a portable radio terminal permits inputting of order acceptance data and so forth, thus improving the operation efficiency.

Prior art techniques concerning such portable radio terminals and like antenna devices, are disclosed in Japanese Patent Laid-Open No. 64-60027 entitled “Antenna Switching System, Japanese Patent Laid-Open No. 3-220902 entitled “Antenna for Portable FM Receiver”, Japanese Patent Laid-Open No. 11-163616 entitled “Antenna Control System”, Japanese Patent Laid-Open No. 2000-49649 entitled “Communication Device, Mobile Radio Device, Base Station and Power Control Method”, Japanese Patent Laid-Open No. 2000-124828 entitled “Communication device, mobile radio equipment, base station and power control method” and so forth.

Such a portable radio terminal is usually used for communication by holding it with one hand in the proximity of the head (or an ear) unless any earphone microphone is used. In such cases, the antenna may touch the user's hand, head, ear, etc. and cause great deterioration of the antenna characteristics. For size reduction, it is conceivable to provide a built-in antenna. Again in this case, deterioration of the antenna characteristics is caused by holding the device with a hand or when the user's hand or head approaches the neighborhood of the built-in antenna while the user is in communication.

### SUMMARY OF THE INVENTION

An object of the present invention is to provide a portable radio terminal device, which can reduce characteristic deterioration due to user's hand, head, etc. and maintain more stable communication characteristics.

According to an aspect of the present invention, there is provided a portable radio terminal device for radio communication by using an antenna provided in a housing capable of being held by one hand, wherein: a first antenna disposed in a lower part of the housing and a second antenna disposed in a lower part of the housing for radio communication, are provided and selectively switched one over to the other for use.

The housing is of a foldable type comprising an upper and a lower housing hinged together by a hinge part, the first and second antennas are disposed in the lower and upper housings, respectively. The first or the second antenna is predetermined to be a normally used antenna. A sensor for sensing that the normally used first antenna or the second antenna is covered with a hand is provided, the antenna in use being switched over to the other antenna in response to the output of a detection signal from the sensor. The sensor is a touch sensor or an optical sensor. A plurality of sensors are used to sense the covering of the antenna. The sensor is an impedance change detecting means for detecting a change in the impedance of the antenna.

According to another aspect of the present invention, there is provided a portable radio terminal device comprising: a plurality of antennas separately provided; a detector for detecting the deterioration of antenna characteristic; and a switch for switching, on the basis of the detected result, the operation from the deteriorated antenna to the own portable radio terminal device.

The portable radio terminal device is a foldable type including a first housing provided with a first antenna and a second housing provided with a second housing which are hinged together by a hinge part. The detector detects the antenna at least a part of which is covered with a hand or is touched with a head. The detector is a touch sensor for detecting the touch of hand or head. The detector is an optical sensor sensitive to light change through the hand or head. The detector detects an impedance change of the antenna. A plurality of detectors are provided.

Other objects and features will be clarified from the following description with reference to attached drawings.

### BRIEF DESCRIPTION OF THE DRAWINGS

FIGS. 1(A) and 1(B) show a schematic view and a block diagram of a first embodiment of the portable radio terminal unit according to the present invention;

FIGS. 1(A) and 2(B) show a schematic view and a block diagram of a second embodiment of the portable radio terminal unit according to the present invention;

FIGS. 3(A) and 3(B) show a schematic view and a block diagram of a third embodiment of the portable radio terminal unit according to the present invention; and

FIG. 4 is a block diagram of a fourth embodiment of the portable radio terminal unit according to the present invention.

### PREFERRED EMBODIMENTS OF THE INVENTION

Preferred embodiments of the present invention will now be described with reference to the drawings.

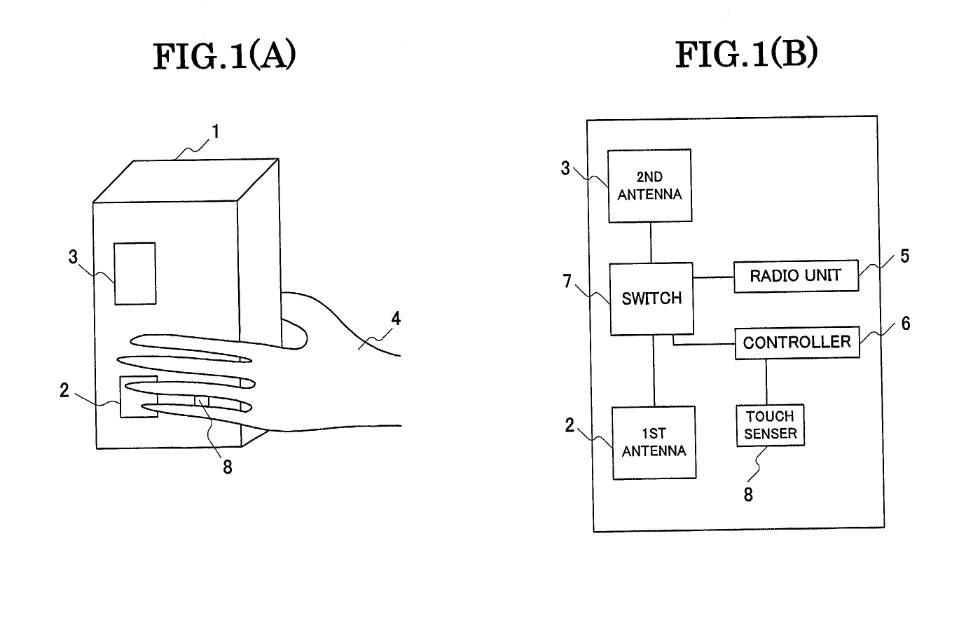

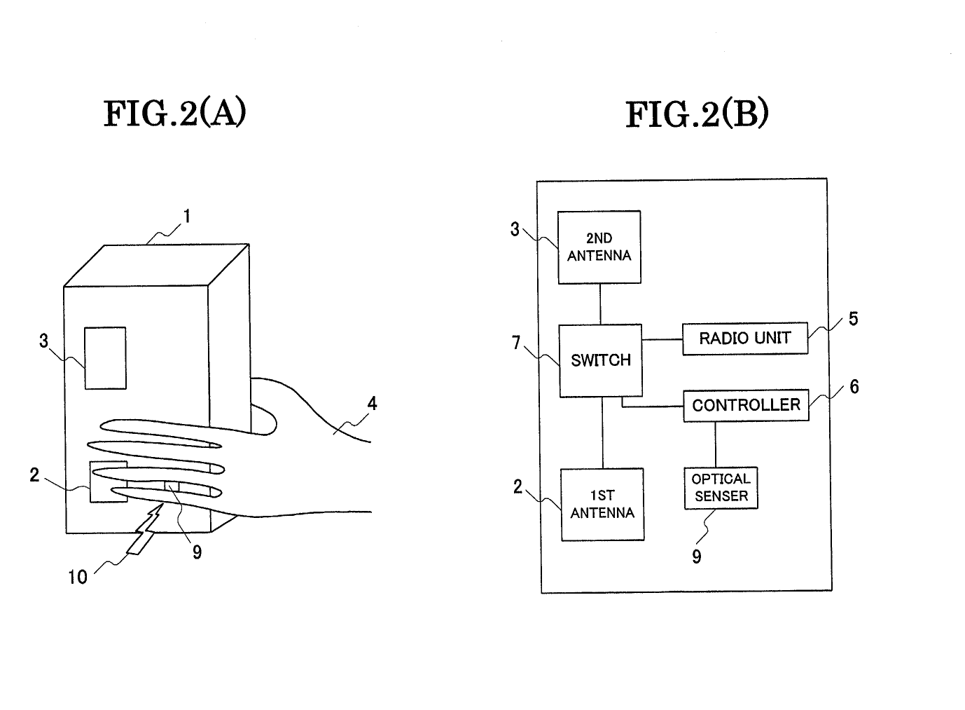

FIGS. 1(A) and 1(B) show a first embodiment of the portable radio terminal unit according to the present invention. FIG. 1(A) is a schematic view showing the portable radio terminal device, and designated (B) is a block diagram showing the same. The illustrated portable radio terminal device comprises an elongate rectangular housing 1 and a plurality of (a first and a second, in this embodiment) antennas (transmission antennas, in this embodiment) 2 and 3 provided on the surface of the housing 1 for radio communication. In this first embodiment, the first and second antennas 2 and 3 are disposed on a lower and an upper part, respectively, of the housing 1.

When the user or operator holds the lower part of the housing 1 with a hand and covers the first transmission antenna 2 which is to be normally used. This situation is detected by a touch sensor 8 which is provided at a position in contact with the user's hand 4. Where the first transmission antenna 2 is large compared to the user's hand, a plurality of touch sensors 8 may be disposed at appropriate portions of the first transmission antenna 2. This arrangement permits more accurate detection of the touch of the first transmission antenna 2 by the user's hand 4. In other words, the arrangement permits detection of the extent of covering of the first transmission antenna 2 by the user's hand.

The portable radio terminal device will now be described with reference to FIG. 1(B). The portable radio terminal device comprises, in addition to the above first and second transmission antennas 2 and 3 and touch sensor 6, a radio part, a control part 6 and a select switch 7, these components being disposed inside the housing 1. In the normal state of the portable radio terminal device, it is controlled by the control part 6 such that the first transmission antenna 2 is switched via the select switch 7 to the radio part 6. When the touch sensor 8 disposed in the neighborhood of the first transmission antenna 2 detects the touch of the neighborhood of the first transmission antenna 2 by the user's hand 4, the control part 6 controls the select switch 7, whereupon the second transmission antenna 2 is connected to the radio part 5 for transmission of the data in the radio part 5 via the second transmission antenna 3.

When the user's hand 4 is separated from the first transmission antenna 2 of the housing 1, the touch sensor 8 detects this situation, whereupon the control part 6 controls the select switch 7 to connect the radio part 5 to the normally used first transmission antenna 2 for transmitting the data.

FIGS. 2(A) and 2(B) show a second embodiment of the portable ratio terminal according to the present invention. FIG. 2(A) is a perspective view, and FIG. 2(B) is a block diagram. As shown in FIGS. 2(A) and 2(B), the second embodiment of the portable radio terminal device, like the preceding first embodiment, comprises a housing 1, a first and a second transmission antenna 2 and 3, a radio part 5, a control part 6 and a select switch 7. This embodiment is different from the first embodiment in that an optical sensor 9 is used in lieu of the touch sensor 8. The optical sensor 9 receives light transmitted through a light-permeable window (not shown). When user's hand 4 covers the light-permeable window, the light 10 is blocked, and the output of the optical sensor 10 is turned off. The output of the optical sensor 9 is fed out to the control part 6 to control the select switch, thus switching, for instance, the first transmission antenna as the normal transmission antenna over to the second transmission antenna for transmitting data form the radio part 5.

As shown above, the optical sensor 9 is disposed in the neighborhood of the first transmission antenna 9. When the user's hand 4 covers the optical sensor 9, the light 10 to be received by the optical sensor 9 is blocked, whereupon the control part 8 switches the first transmission antenna 2 over to the second transmission antenna 3. However, the portable radio terminal device is used in a dark place, the optical sensor 10 may not be normally operated due to insufficient light 10. Accordingly, as the optical sensor 9 may be used one of reflecting type. More particularly, the optical sensor 9 may be provided with a light-emitting part and a light-receiving part such that the light-receiving part receives and senses light emitted from the light-emitting part and reflected by the user's hand (or fingers) 4.

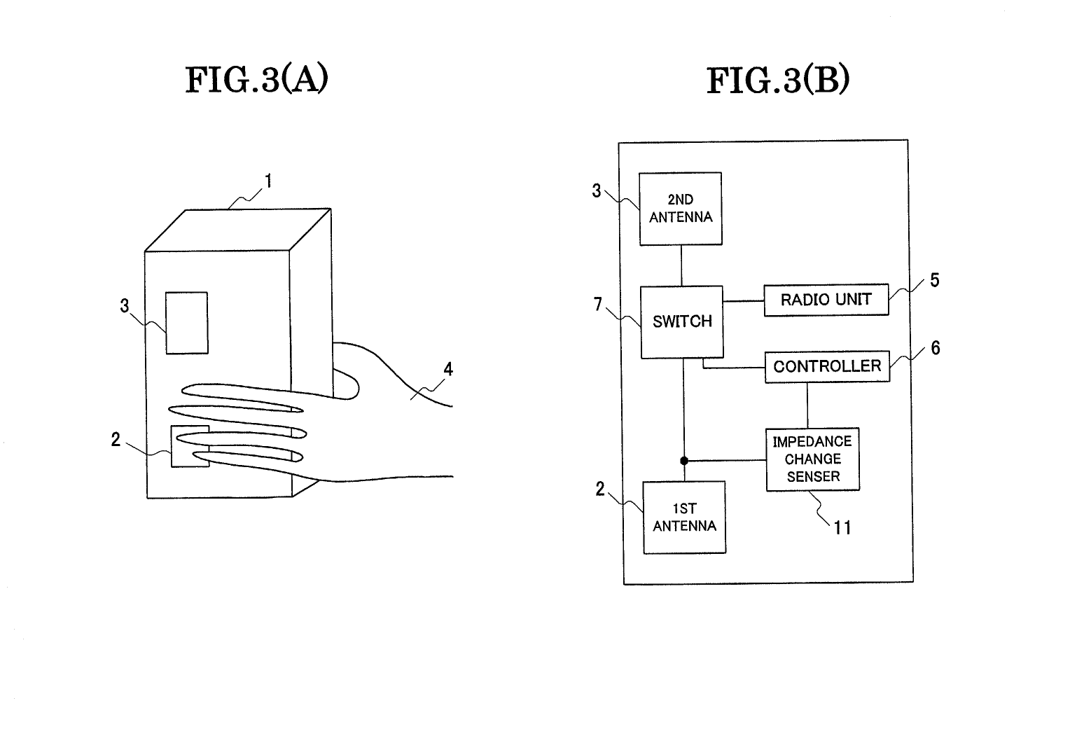

FIGS. 3(A) and 3(B) show a third embodiment of the portable radio terminal device according to the present invention. FIG. 3(A) is a perspective view, and FIG. 3(B) is a block diagram. This portable radio terminal device, like the previous first embodiment, comprises a housing 1, a first and a second transmission antenna 2 and 3, a radio part 5, a control part 6 and a select switch 7. However, this embodiment features that the provision, in lieu of the touch sensor 8 in the first embodiment or the optical sensor 9 of the second embodiment, of an impedance change sensor (or impedance change detecting means) 11 for detecting the impedance of the transmission antenna, for instance the first transmission antenna 2.

The impedance change sensor 11 detects impedance changes between the first transmission antenna 2 and the select switch 7. A detection signal outputted from the impedance change sensor 1 is fed to the control part 6. In response to the detection signal, the control part 6 switches the first transmission antenna 2 over to the second transmission antenna 3 for data from it therethrough. The threshold impedance change or the switching varies in dependence on the characteristic and the disposition status of the first and second transmission antennas 2 and 3, and is predetermined by taking the actual use status such as the field value into considerations.

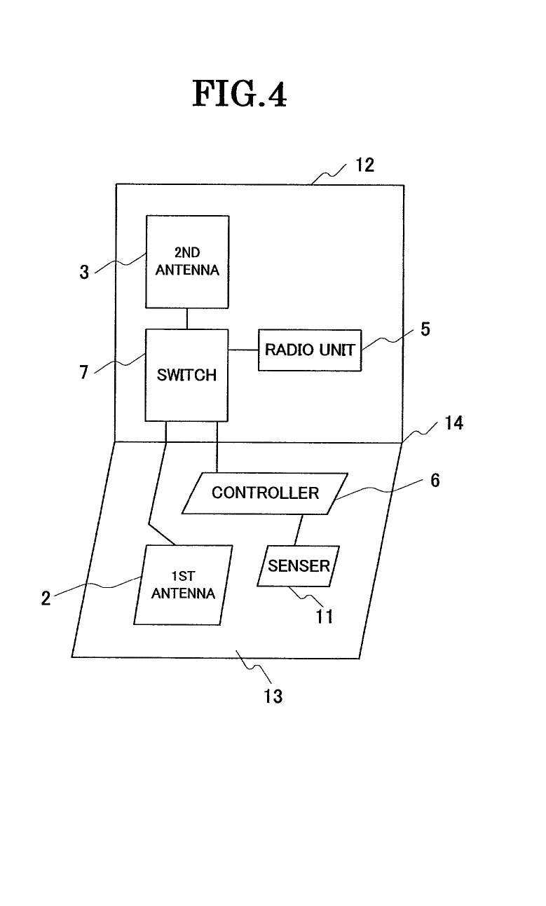

FIG. 4 is a schematic block diagram showing a fourth embodiment of the portable radio terminal device according to the present invention. This portable radio terminal device is of a foldable type comprising an upper (a first ) and a lower (a second) housing 12 and 13 hinged together by a hinge (or movable) part 14. In the lower housing 13, a first transmission antenna 2, a control part 6 and a sensor (i.e., impedance change sensor) 11 are disposed. In the upper housing 12, a second transmission antenna 3, an antenna select switch 7 and a radio part 5 are disposed. The control part 6 switches the antenna select switch 7 according to a sense signal from the sensor 11. More specifically, when the user holds the lower housing 13 with a hand, the sensor 11 senses characteristics deterioration of the normally used first transmission antenna 2, whereupon the control part 6 switches the antenna select switch 7.

As has been understood from the foregoing, with the portable radio terminal device according to the present invention the following pronounced practical advantages are obtainable. That is, a plurality of (two, for example) transmission antennas (i.e., first and second transmission antennas) are disposed in the lower and upper parts, respectively, of the housing. Normally, the transmission antenna in the lower part of the housing, for instance, is used for transmitting data. When the user holds the lower part of the housing with a hand and covers a region containing the transmission antenna with the hand, the touch sensor senses this, whereupon the transmission antenna is switched over to the one in the upper part of the housing. Thus, it is possible to reduce deterioration of the antenna characteristics due to the effects of the user's head or hand and permits satisfactory data transmission.

Changes in construction will occur to those skilled in the art and various apparently different modifications and embodiments may be made without departing from the scope of the present invention. The matter set forth in the foregoing description and accompanying drawings is offered by way of illustration only. It is therefore intended that the foregoing description be regarded as illustrative rather than limiting.

What is claimed is:

1. A portable radio terminal device for radio communication by using an antenna provided in a housing capable of being held by one hand, wherein:
s first antenna disposed in a lower part of the housing and a second antenna disposed in a lower part of the housing for radio communication, are provided and selectively switched one over to the other for use.

2. The portable radio terminal device according to claim 1, wherein the housing is of a foldable type comprising an upper and a lower housing hinged together by a hinge part, the first and second antennas are disposed in the lower and upper housings, respectively.

3. The portable radio terminal device according to one of claims 1 or 2, wherein the first or the second antenna is predetermined to be a normally used antenna.

4. The portable radio terminal device according to claim 3, wherein a sensor for sensing that the normally used first antenna or the second antenna is covered with a hand is provided, the antenna in use being switched over to the other antenna in response to the output of a detection signal from the sensor.

5. The portable radio terminal device according to claim 4, wherein the sensor is a touch sensor.

6. The portable radio terminal device according to claim 4, wherein the sensor is an optical sensor.

7. The portable radio terminal device according to one of claims 4 and 5, wherein a plurality of sensors are used to sense the covering of the antenna.

8. The portable radio terminal device according to claim 4, wherein the sensor is an impedance change detecting means for detecting a change in the impedance of the antenna.

9. A portable radio terminal device comprising:
a plurality of antennas separately provided; a detector for detecting the deterioration of antenna characteristic; and
a switch for switching, on the basis of the detected result, the operation from the deteriorated antenna to the own portable radio terminal device.

10. The portable radio terminal device according to claim 9, wherein the portable radio terminal device is a foldable type including a first housing provided with a first antenna and a second housing provided with a second housing which are hinged together by a hinge part.

11. The portable radio terminal device according to claim 9 or 10, wherein the detector detects the antenna at least a part of which is covered with a hand or is touched with a head.

12. The portable radio terminal device according to one of claims 9-11, wherein the detector is a touch sensor for detecting the touch of hand or head.

13. The portable radio terminal device according to one of claims 9-11, wherein the detector is an optical sensor sensitive to light change through the hand or head.

14. The portable radio terminal device according to one of claims 9-11, wherein the detector detects an impedance change of the antenna.

15. The portable radio terminal device according to one of claims 1-14, wherein a plurality of detectors are provided.
